(19) United States
(12) Patent Application Publication
(10) Pub. No.: US 2026/0201877 A1
(43) Pub. Date: Jul. 16, 2026

(54) Computer-Implemented Process for Controlling and/or Regulating a Single-Compressor Station with a Compressor

(71) Applicant: KAESER KOMPRESSOREN SE COBURG, Coburg (DE)

(72) Inventors: Florian Wagner, Coburg (DE); Tobias Sprügel, Coburg (DE)

(21) Appl. No.: 19/134,150

(22) PCT Filed: Nov. 2, 2023
(86) PCT No.: PCT/EP2023/080594

§ 371 Date: May 29, 2025

(30) Foreign Application Priority Data
Dec. 2, 2022 (DE) 10 2022 132 033.2

(51) Int. Cl. F04B 49/06

(52) U.S. Cl. CPC F04B 49/065

(57) ABSTRACT

The invention relates to a computer-implemented method for open-loop and/or closed-loop control of a single-compressor station having a compressor (Cl), wherein the single-compressor station is intended to keep a detected actual pressure in a pressurised fluid system in a pressure interval between an upper pressure limit and a lower pressure limit. A tree structure having nodes (5 to lü) in the form of simulated system states is generated from simulated load commands, wherein, for immediately subsequent time points ti+l (i=l . . . n−1) proceeding from the selected system states at the time point ti, different load commands and the system states resulting therefrom are simulated, wherein invalid system states are deleted, wherein a prevailing actual pressure is assigned a system state pressure class, wherein a control state of the compressor that is to be expected at the time point ti+1 is determined and is assigned a control state class, wherein, for each system state, the system state which has a lowest cost value is selected, wherein, from all nodes (5 to 10) selected at the time point tn, the load command which has the lowest cost function is selected, and wherein the load command at the time point tl which has been stored in relation to said selected load command is transmitted to the compressor (Cl).

The invention relates to a computer-implemented process for controlling and/or regulating a single-compressor station with the features of the preamble of claim 1.

This is a process for the optimal control of a single-compressor station. The single-compressor station consists of exactly one compressor and at least one compressed air storage. The compressed air storage can be formed by a compressed air tank. Instead of a conventional compressed air tank, compressed air pipes or any other type of compressed air storage in containers can also be used, or hybrid forms can create an effective buffer volume.

An actual pressure and an actual operating state are recorded. The single-compressor station is intended to maintain the actual pressure within a pressure fluid system within a pressure range between an upper pressure limit and a lower pressure limit, despite possible fluctuating extraction of pressure fluid from the system. Thus, the aim is to two predetermined pressure limits are observed

Various processes are known in the prior art.

The use of pressure switches has been common for decades. When a predefined minimum pressure is undershot, the compressor is switched to load and thus supplies air. When a predefined maximum pressure is exceeded, the compressor is switched off from the load and thus does not supply air. The specific operating state of the compressor—standstill, idle, or load operation—is only indirectly influenced by the pressure switch. In particular, the pressure switch cannot explicitly influence whether the compressor is at a standstill or idle state when it is switched off from the load. The pressure switch also does not take into account that when issuing a load command ‘Load,’ the compressor may first need to perform a motor start lasting several seconds up to 20 seconds. Therefore, the lower pressure limit must be set significantly higher than the pressure that must not actually be undershot in the compressed air storage. This leads to an increased average pressure, which negatively affects energy efficiency.

The process applies a quality criterion to evaluate different control commands, i.e., different load commands. The quality criterion is indicated by a cost value. This quality criterion can, for example, be energy expenditure; additionally, further optimization criteria can be considered, or multiple aspects can be combined into a single criterion. A time grid with multiple steps t0 to tn (n>1) is defined, in which a load command (LC) is determined and transmitted to the compressor. The transmitted load command is determined through a simulation of different load commands based on a model.

In the state of the art, the use of a mathematical model for the Investigation of the future impact of the load command combinations has been proposed. Model Predictive Control (MPC) is a modern method for the predictive control of complex, typically multi-variable processes. In MPC, a discrete-time dynamic model of the process to be controlled is used to calculate the future behavior of the process depending on the input signals. This enables the calculation of the optimal input signal—within the meaning of a quality function that leads to optimal output signals. Input, output, and state constraints can be considered simultaneously. The examined time horizon is divided into, for example, equidistant discrete time intervals. One Consideration of all possible sequences of just two control commands, such as “Load” or “non-load”, using a so-called brute-force approach does not work for sufficiently long prediction horizons with a sufficiently fine temporal resolution of the steps t0 to tn, because too many command combinations need to be examined, since the solution space grows exponentially, making it impossible to determine the optimal control commands in real time. If, for example, a time horizon from to to t500 is examined in an interval of 600 seconds with a temporal resolution of 1 second, 2600 different sequences of control commands result. This incredible quantity of control commands cannot be analyzed using a brute-force approach with any data processing system.

To avoid this explosion or the size of the solution space in the brute-force approach, another solution is to reduce the temporal resolution. Instead of a resolution of seconds, a resolution of minutes, for example, is used.

“Through this simplification of the calculation, a sequence of a few stationary states is considered, while dynamic processes are disregarded. If, once again, a time period of 600 seconds, i.e., 10 minutes, is considered with a temporal resolution of 60 seconds, the sequence to be examined ranges from t0 to t10, resulting in a solution space size of 2¹⁰=1024 control commands. This small number of control commands can then be managed using a conventional optimization algorithm or even a brute-force approach. The price of this complexity reduction is that dynamic processes can only be considered to a limited extent or not at all. For the control of compressors in the compressed air industry, this consideration of only distinct stationary states is not applicable, as these are dynamic processes on the order of seconds. As a result, essential influencing factors would not be included in the optimization calculation for correct optimization.

A process for controlling a compressed air system is known from EP 3 974 918 A1. In this process, an MPC process is modified so that the temporal resolution over the forecast horizon under investigation can be dynamically adjusted. Only a short period of time is considered, with high temporal resolution and a high level of detail. Subsequently, the result of the considered short period is extrapolated to a significantly longer period.

In the short period, dynamic processes can therefore also be considered, but not in the longer period. If there are many changes in the compressed air consumption curve, the analysis is more precise than if the curve shows few changes. This process aims to find a good solution in a sufficiently fast time using the MPC process.

The invention is based on the objective of providing a process for controlling a single-compressor station, whereby the quality criterion and thus the cost value are optimized and predefined boundary conditions are met with high probability. With known technical properties of the single-compressor station, the quality depends only on the forecast of compressed air consumption. With an ideal forecast of compressed air consumption, the quality criterion should indeed be optimized.

This underlying objective of the invention is now solved by a process with the features of claim 1. This is a computer-implemented process for controlling and/or regulating a single-compressor station with a compressor, whereby the actual pressure and actual operating status of the compressor are recorded, allowing the single-compressor station to function within a pressure fluid system despite possible fluctuating extraction of pressure fluid.

From the pressure fluid system, the actual pressure is to be maintained within a pressure interval between an upper pressure limit and a lower pressure limit, whereby a time grid with multiple steps t0 to tn is defined, and a load command (LC) is determined and transmitted to the compressor. According to the invention, the process is characterized in that a tree structure with nodes in the form of simulated system states and edges in the form of simulated load commands is created according to the following procedural steps a) and b), whereby
a. to determine the load command to be transmitted to the compressor, starting from the actual operating state at the current point of time t0, for the different load commands and the resulting system states are simulated for the next point of time t1, whereby the expected actual pressures and cost values are calculated for the system states, whereby the respective cost value depends on the required energy, whereby the system states are classified as invalid system states and valid system states, whereby at least the valid system states are stored, whereby for each valid system state the expected actual pressure at the point of time t1 is assigned and stored in a system state pressure class, whereby for each valid system state the expected control state of the compressor at the point of time t1 is determined and assigned to a control state class and stored, whereby all system states resulting from the simulated load commands are selected or a subset of the system states resulting from the simulated load commands is selected, whereby for each system state simulated for the point of time t1 the simulated load command is stored,
b. whereby for the next following point of times ti+1 (i=1 . . . n−1), starting from the selected system states at the point of time ti, different load commands and the resulting system states are simulated, whereby the expected actual pressures and cost values are calculated for the system states, whereby the system states are classified as invalid system states and valid system states, whereby at least the valid system states are stored, whereby for each valid system state the expected control state of the compressor at the point of time ti+1 is determined and assigned to a control state class and stored, whereby for each system state simulated for the point of time ti+1 at least the originally simulated load command at the point of time t1 is stored, whereby for each system state resulting from the simulated load commands with the same system state pressure class and the same control state class, at least the system state with the lowest cost value is selected as a node at the point of time ti+1,
c. whereby from all system states selected at the point of time tn, the system state with the lowest cost value is determined,
   whereby the load command stored for this single selected and determined system state at the point of time t1 is transmitted to the compressor.

The actual operating state of the single-compressor station at the point of time t0 can be described by different state variables. The status variables include the current system pressure p and/or the currently stored air volume in the compressed air reservoir and/or the current ambient pressure. The state variables also include the condition of the compressor, such as standstill, idle, or load operation, or, in the case of variable-speed compressors, the speed level of the compressor. Starting from the actual state and the state variables describing the actual state, a graph in the form of a tree with simulated system states is now generated for the following points of time t1 to tn.

The simulated system states are described by the state variables and, if applicable, additional Parameters. At least the operating state of the compressor is used as a state variable. The system state describes the simulated state of the single-compressor station This simulated state includes at least the simulated operating state of the compressor, e.g., standstill and load operation, as well as a derived quantity and may include additional boundary conditions. As a derived quantity, an actual pressure is used in the single-compressor station. At least the operating state of the compressor and the actual pressure are used as state variables. Another boundary condition can be a timer that indicates how long the compressor has already been in the simulated operating state. Another boundary condition may be the temperatures present in or on the compressor at certain points, e.g., the temperature of the oil in the oil circuit, the ambient temperature at the installation site, and the temperature of the compressed air at the end or during the compression process. Examples of this characterization can be found in the figure description.

The nodes of the tree correspond to the simulated system states. The nodes are connected by edges. The edges connecting the nodes correspond to the simulated load commands. By applying the load command in the model, the subsequent system state is simulated.

Starting from a certain set of nodes or system states at the current point of time, all possible load command combinations are generated for a subsequent point in time. In the very first point of time, an initial node is started in the procedure step a. Possible load command combinations are, for example, “Load” or “Non-load”. In another implementation, variable-speed compressors can also be considered with the help of speed levels For example, the speeds can be defined as ‘No-Load’, Load at 0%, 25%, 50%, 75%, or 100%. And thus, six different load commands are simulated.

In the next step, a mathematical model is called to calculate certain state variables and/or derived quantities and/or parameters. With the mathematical model, the expected actual pressures and other state variables, such as the required energy and the resulting states of the compressor, are simulated and stored for all generated load command combinations.

The individual cost values for the generated load commands are calculated from the state variables. The respective cost value depends in particular on the energy to be expended. The cost value, in one embodiment, is a function that increases with the energy to be expended. The cost value at least indicates or depends on how much electrical energy is consumed by the compressor within a specific time period. Furthermore, additional key figures can be taken into account in the cost value. However, additional state variables can also be included in the calculation. Beyond pure energy efficiency, other aspects can also be considered in the quality criterion, i.e., in the cost value, this can include, for example, the consideration of a heat recovery system. In the model for calculating system states, recovered heat is taken into account, with the cost value additionally being a function of the recovered heat. These additional key figures can thus be, for example, the amount of recoverable heat within a specific time period. If additional key figures are considered alongside electrical energy, they must be appropriately combined in the cost value calculation. In the context of offsetting electrical energy with additional key figures, weightings can also be incorporated to allow other key figures to have a weaker or stronger influence depending on the electrical energy. By means of these weightings, it is also possible to weight several additional key figures among themselves and in relation to electrical energy. Furthermore, the cost value can additionally be a function of the expected wear of the compressor.

In the process, the tree is pruned. When expanding the tree or graph, invalid system states may be simulated, For example, a load command combination could result in the the lower or upper pressure limit being exceeded. As a result, this node is not used as a starting point for further load command combinations at the next point of time. This is followed by cutting off this branch of the tree. As a result, the number of possible solutions and the solution space are significantly reduced, since cutting off this branch also eliminates the need to further examine all solutions derived from it.

The system state pressure classes consist primarily of individual pressure intervals, where the pressure intervals are adjacent to each other and do not overlap. The expected pressure range specifically covers the area between the lower pressure limit and the upper pressure limit. The expected pressure range preferably also covers values above the upper pressure limit and below the lower pressure limit. It is conceivable that the system state pressure classes consist of equally sized intervals between the upper and lower pressure limits. However, it is also conceivable that the intervals have different sizes. Additionally, one or more pressure state classes can be defined for pressure values above the upper pressure limit and below the lower pressure limit. It is possible to define the pressure state classes based on a pressure-derived quantity, such as the air mass or air volume stored in the compressed air storage.

The control state results from the operating state of the compressor. The operating state can specifically include the conditions “load operation” and “standstill”. Furthermore, the operating state can include the “idle” state. Furthermore, the operating state can include load states at specific rotational speeds.

This operating state of the compressor can also be referred to as the compressor state. For example, whether the compressor is in the operating state “Standstill”, “Idle” or “Load operation”.

The control state classes are formed by discretising the control states. The operating states “Load operation” and “Standstill” and Idle state form discrete values in one configuration. If, in another configuration, load conditions at different rotational speeds are possible and thus simulated, the rotational speed can be divided into intervals to form discrete control state classes.

Furthermore, the operating state preferably records how long the compressor has already been in this state without a state change.

Preferably, this is achieved using a timer, where the timer values are also divided into intervals to form discrete control state classes. The control state class includes a timer that tracks how long the compressor has remained in its current state. This timer can serve as a boundary condition for a state change, determining whether the compressor may be switched off, whether a minimum required run-on time in idle state is maintained, or whether the minimum time for pressure build-up in idle state has been reached, allowing the compressor to switch to the load state. The timer is preferably limited to a maximum value during calculation, even if the compressor has already remained in the current state longer than the maximum value, in order to restrict the possible timer values and thus reduce the control state classes.

In procedural step a, either all system states resulting from the simulated load commands are selected, or a subset of the system states resulting from the simulated load commands is selected. It can be assumed that in the first simulation of the load commands for the point of time t1, only system states in different system state classes are generated. This means that initially, each system state class contains at most one system state. Therefore, all system states can be selected here first. However, in a preferred embodiment of the process, it is also advisable to check for the point of time t1 whether multiple system states fall into a system state class, and if so, to select only the one with the lowest cost value. This enables the same verification to be carried out for all points of time from t1 to tn.

In process step b, for the subsequent points of time ti+1 (i=1 . . . n−1), different load commands are simulated again, starting from the nodes of the point of time ti, namely the system states resulting from the selected simulated load commands with the lowest cost value. This is repeated until the point of time tn is reached.

For each system state resulting from the simulated load commands with the same system state pressure class, the same control state class, and the same expected actual operating state, the load command with the lowest cost value is selected as a node in process step b. If multiple system states fall into a system state class, at least the one with the lowest cost value is pursued. It is conceivable that only the system state with the lowest cost value or multiple system states, particularly those with the lowest cost values, are selected. These selected system states are followed up.

It is conceivable that in procedural step b, not all selected system states are considered, and not all selected system states at the point of time ti generate additional nodes at the next point of time ti+1, whereby the selected system states are sorted by cost value, and only the system states with the lowest cost values generate further system states for the next point of time ti+1. This reduces the number of system states or nodes, which in turn decreases the required computing power and memory demand. However, the optimal solution may no longer be found.

It is conceivable that if the number of system states at a given point of time exceeds a maximum value, only 10% to 50%, or specifically 20%, of the system state classes with the lowest cost value are pursued further.

Preferably, adjacent points of time tj and tj+1 for j=0 to n−1 have an equidistant spacing. Adjacent points of time tj and tj+1 for j=0 to n−1 can specifically have an equidistant spacing of less than 10 seconds and more than 0.001 seconds to also represent dynamic processes. In a preferred embodiment, the distance between adjacent points of time tj and tj+1 is 0.01 seconds to 2 seconds.

From all nodes selected at the point of time tn, the system state with the lowest cost value among all system state classes is chosen, with the stored load command of the point of time t1 for this single selected system state being transmitted to the compressor as the load command (LC).

It is conceivable that for each simulated load command at the point of time ti+1, at least the initially simulated load commands at the points of time t1 . . . tl are stored, whereby 1>=2. For example, the first 5 load commands can be saved (1=5).

Since the number of system state classes is predetermined and only a maximum of one system state per system state class is considered further, exponential growth of the solution space is avoided. The number of points of time can in particular be greater than or equal to 10 (n>=10), and specifically greater than or equal to 20 (n>=20). The number of points of time is less than 10,000.

The process uses two lists, namely stores the previous system states at the point of time tj, and a second list, stores the newly simulated system states at the point of time tj+1, which are derived from the previous system states based on possible load commands. Once all system states for the current point of time tj+1 have been calculated, invalid system states are removed from the solution space, and a reduction to the system state with the lowest cost value in each existing system state class is performed, this second list is then declared as the first list for the next point of time ti+1. The second list replaces the previously first list. The second list then serves as the new first list. The originally first list is deleted, and a new second list is created for the point of time tj+2.

The inventive process enables a detailed analysis over the entire forecast period. The process is applicable in real-time by reducing the load command combinations to be examined to a manageable scope. Optimum control is realised because the optimum of the underlying optimisation problem is determined. The two key factors that can influence the determination of the optimum are the granularity of the discretization of the derived quantity, e.g. the pressure, pressure, and the forecast of compressed air consumption. The process can be applied directly in a compressor control system or on another computer or in the cloud, given sufficient computing power. The process is implemented in a program code that is stored in the memory of a data processing system and can be executed by a processor. The data processing system is wirelessly or wired connected to the single-compressor station and can transmit the control command LC to the single-compressor station via the connection.

A key systematic advantage of the inventive process compared to simulation-based control of compressed air stations is that, in conventional processes, the developer's experience influences the selection of heuristics used to determine the switching strategies to be simulated, thereby directly affecting the quality in a subjective manner.

In the inventive control process, heuristics for determining the switching strategies to be simulated are no longer necessary, as all conceivable control trajectories corresponding to the implementation of a switching strategy over the forecast horizon are implicitly examined within the optimization calculation. A pre-selection is no longer necessary. Thus, the quality of the process depends only on the quality of the forecast of compressed air consumption and the granularity of the discretisation.

There are now a variety of possibilities to design and further develop the process. Reference may first be made to the patent claims subordinate to patent claim 1. In the following, a preferred embodiment of the invention is explained in more detail based on the drawing and the accompanying description. The drawing shows:

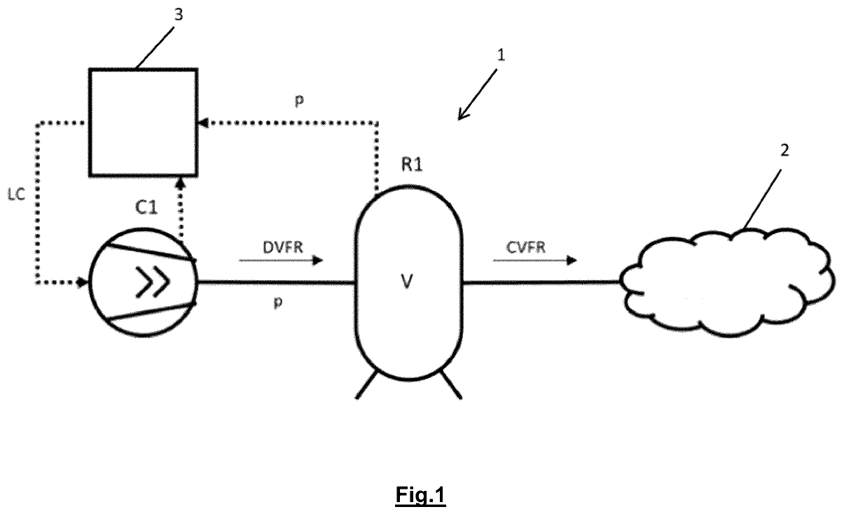

FIG. 1 in a highly schematic representation of a single-compressor station,

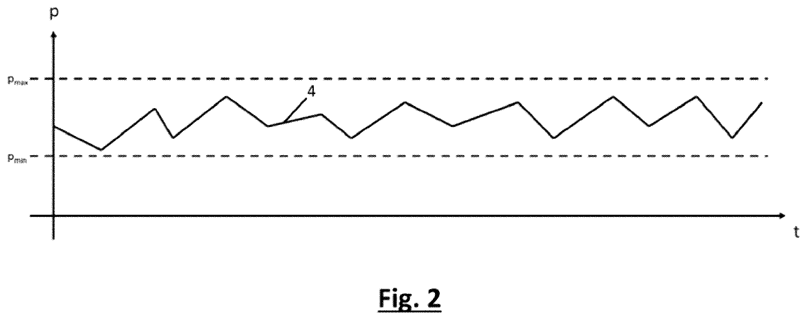

FIG. 2 is a highly schematic simplified diagram in which the system pressure is plotted over time,

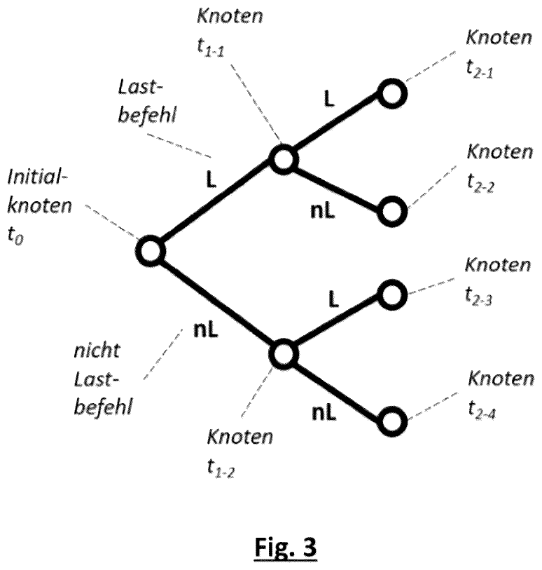

FIG. 3 is a diagram illustrating the structure of the graph, with two edges emanating from each node in the form of the load commands “not load” and “load” starting from the initial node at the point of time t0.

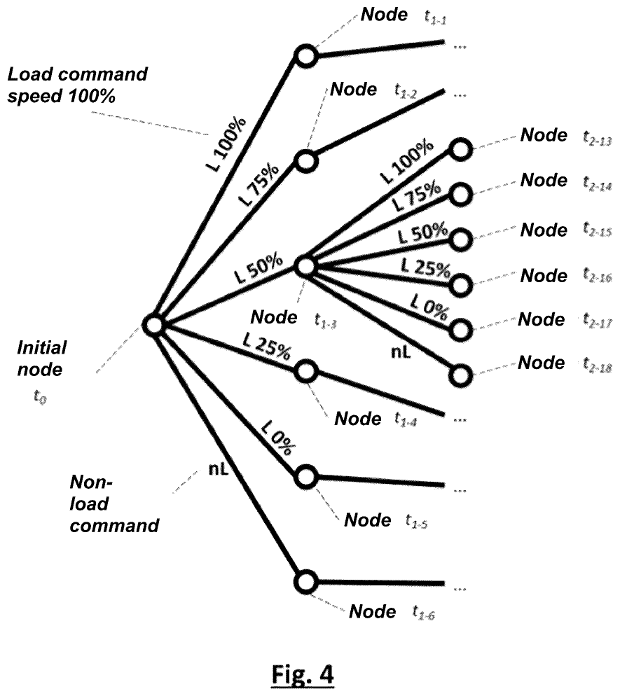

FIG. 4 is another diagram illustrating the structure of the graph when more than two edges, meaning more than two load commands per node, are simulated,

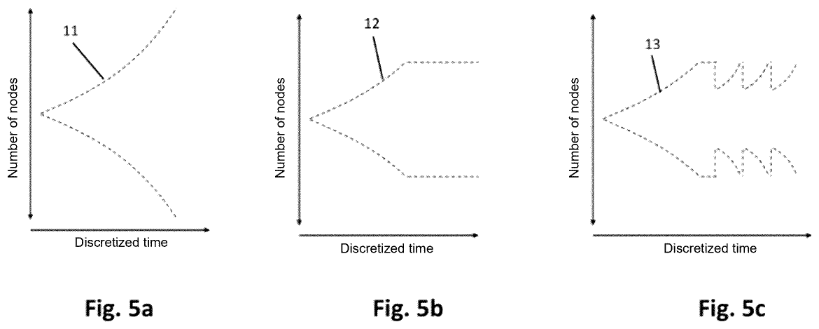

FIG. 5a shows the number of nodes plotted over the time steps when applying a brute-force approach,

FIG. 5b shows the number of nodes plotted over the time steps in the inventive process, considering pressure limits and discretisation of the system pressure,

FIG. 5c shows the number of nodes plotted over the time steps in the inventive process, considering pressure limits, discretisation of the system pressure, and cyclic reduction of classes,

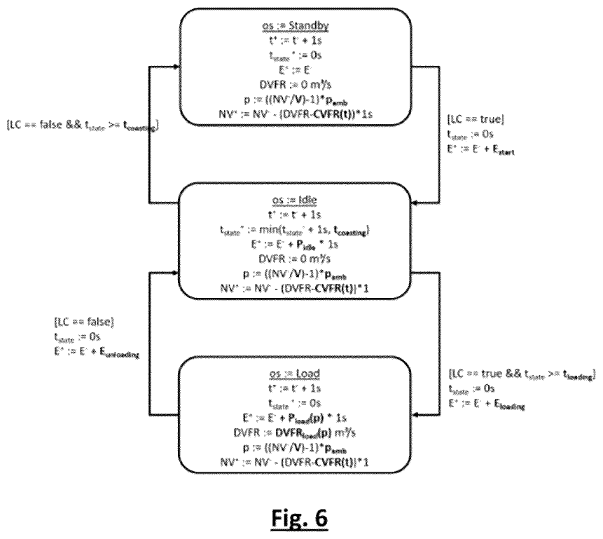

FIG. 6 is a highly schematic representation of a simplified mathematical model for replicating the dynamic behavior of the single-compressor station,

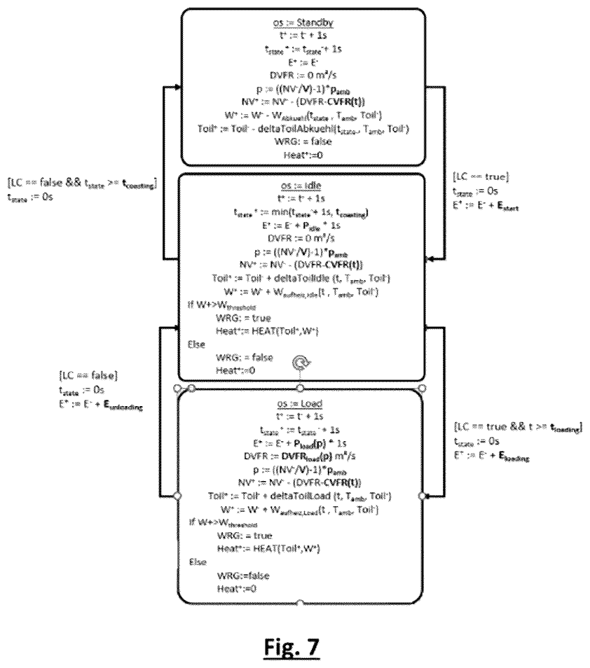

FIG. 7 is a schematic representation of the structure of a simplified mathematical model for replicating the dynamic behavior of the single-compressor station, considering a heat recovery cycle to utilize the heat contained in the oil, which is generated during the compression of air in the compressor block, whereby

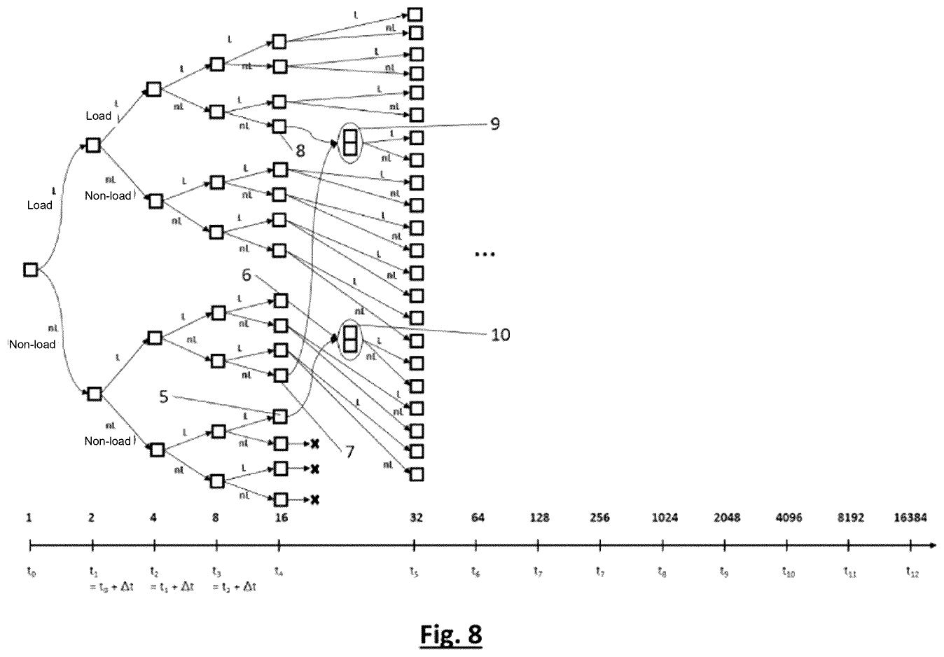

FIG. 8 is another diagram illustrating the structure of the graph, whereby the aggregation of nodes into system state classes is shown.

FIG. 1 shows a single-compressor station 1. The single-compressor station 1 has a compressor C1 and a compressed air storage R1. The Compressed air storage R1 has a volume V. Furthermore, the single-compressor station 1 has at least one compressed air consumer 2. A control algorithm 3 specifies a load command LC, determining when the compressor C1 should supply air or not, taking into account the system pressure p in the compressed air storage R1. In the control algorithm 3, knowledge about the technical properties of the compressor C1 has been implemented. The control algorithm 3 can specifically determine a delivery volume flow DVFR.” The compressed air flow CVFR is supplied to the compressed air consumers 2. The difference between the volume flows DVFR and CVFR determines how the amount of air stored in the compressed air storage R1 changes. The system pressure p results from the stored air volume and the volume V of the compressed air storage R1.

Based on FIG. 2, the control task is now described in more detail. FIG. 2 shows the system pressure p plotted over time t. Furthermore, a pressure upper limit _{Pmax} and a pressure lower limit _{Pmin} are marked. The pressure upper limit pₘₐₓ and the pressure lower limit _{Pmin} are constant over time in this example. It is conceivable, that over time, the pressure upper limit pₘₐₓ and the pressure lower limit pₘᵢₙ may vary. The system pressure p described by the pressure curve 4 should now be maintained above the minimum required pressure pₘᵢₙ and below the maximum permissible pressure pₘₐₓ. The control algorithm 3 is intended to determine a sequence of load commands, such as load or no-load for the compressor C1, whereby a cost value is minimised. The cost value depends in particular on the electrical energy to be expended.

A prerequisite for the functioning of the process is that the control algorithm 3 knows the technical properties of the compressor C1.

The control algorithm 3 must know the current state of the compressor C1. The control algorithm 3 must know the current pressure p. The control algorithm 3 knows the effective buffer volume V and the control algorithm 3 influences the compressor C1 via the load command LC.

The control algorithm 3 is capable of estimating the current and future expected compressed air consumption CVFR. Depending on the operating state of the system pressure p, the compressor C1 delivers the delivery volume flow DVFR into the compressed air storage. Depending on the operating state and the system pressure p, the compressor C1 consumes the electrical power P. The compressed air consumer 2 extract the consumption volume flow CVFR from the compressed air storage R1. The difference between the delivery volume flow DVFR and the consumption volume flow CVFR determines the change in the amount of air stored in the compressed air storage R1. The air stored in the compressed air storage R1 determines the system pressure p.

The fundamental cycle of the present process consists of the following steps. In a first step, the current situation is recorded. In a second step, a forecast of compressed air consumption is created. The creation of the forecast for compressed air consumption is known to the expert and is not further described at this point. In a third step, a sequence of load commands is determined over time, with a particular focus on optimization calculations.

An optimal sequence of load commands is determined here. This optimal sequence of load commands can also be referred to as a control trajectory. In a fourth step, the first load command of the control trajectory, i.e., the sequence of load commands, is now implemented. We are now waiting for the end of the cycle. After the end of the cycle, the first step is started again, and process steps 1 to 4 are repeated. In the following, the optimization calculation may now be described in more detail:

A graph, specifically a tree of load command combinations, is spanned. Based on a certain number of nodes at the current point of time, all possible load command combinations are generated for a subsequent point of time. At the very first point of time, an initial node is started. This approach is shown in FIG. 3 using three consecutive points of time t0, t1, and t2. Possible load command combinations are “L” load command or “nL” non-load command. Starting from an initial node, the load command “L” creates node t1-1 and the load command “nL” of the nodes t1-2. Starting from the nodes t1-1, the nodes t2-1 and t2-2 are created, and starting from the node t1-2, the nodes t2-3 and t2-4 are created through the application of the load commands “L” and “nL”.

In another implementation, variable-speed compressors can also be considered with the aid of discrete speed levels. This is shown in FIG. 4. In FIG. 4, the rotational speed is defined as a load command with 0%, 25%, 50%, 75%, or 100% of the speed. Thus, in this simplified example of a possible implementation, the two load commands of a fixed-speed compressor generate possible load commands for a variable-speed compressor. Starting from the initial node t0, the nodes t1-1, t1-2, t1-3, t1-4, t1-5 and t1-6 are created through the application of load commands “L 100%”, “L 75%”, “L 50%”, “L 25%”, “L 0%” and “nL”.

In the next step, a mathematical model is called to calculate certain state variables and/or derived quantities. A highly simplified model of the single-compressor station is shown in FIG. 6 as a hybrid automaton. “In the hybrid automaton, the discrete state variables are modeled as automaton states, which are linked together via directed edges. The directed edges define which state transitions are possible in the system and under which conditions a transition occurs. In an automaton state, difference equations describe the system behavior when the state is active. During a state transition, it is possible to initialize state variables.

In FIGS. 6 and 7, two automata are now shown. Different state variables and parameters are used here.

The Pidle parameter describes the idle performance. P1oad(P) describes the load operation performance depending on the pressure. Tioading describes the duration for the pressure build-up. Tcoasting describes the idle time. Estart describes the switching energy for the compressor start. Eloading describes the switching energy for the pressure build-up. Eunloading describes the switching energy for pressure reduction.

V denotes the effective buffer volume. CVFR(t) denotes the time-dependent compressed air consumption. “os” denotes the operating state of the compressor. “t” denotes the time since the start of the calculation. “tstate” denotes the time that the compressor has already remained in the operating state. “E” describes the consumed electrical energy since the beginning of the calculation. “NV” describes the air stored in the compressed air storage.

In FIG. 7, the following parameters are also used:

The function WAbkueh1(tstate, Tamb, Toil) describes the cooling behavior of the compressor based on a metamodel. The function Waufheiz(tstate, Tamb, Toil) describes the heating behavior of the compressor based on a metamodel.

The function deltaToilAbkuehl(tstate, Tamb, Toil) describes the cooling behavior the oil temperature. The function deltaToilIdle(tstate, Tamb, Toil) describes the heating behaviour of the oil temperature in the idle operating state. The function deltaToilIdle(tstate, Tamb, Toil) describes the heating behavior of the oil temperature in the idle operating state. The state variable W describes the amount of heat in the compressor. The state variable “Heat” describes the amount of recoverable heat using a heat recovery cycle (WRG cycle).

The automaton shown in FIG. 6 distinguishes between the three discrete states os=standby (standstill), Idle (idle state) and load (load operation). If the automaton is in the discrete state Standby and a load command LC=true is present, it transitions to the discrete state Idle. Variables marked with “+” represent the current values, while variables marked with “−” represent the values from the previous point in time. First, regardless of the state, the current time variable t⁺ is increased by one second or the corresponding the point of time t⁺:=t−+1 s. In the example, the time interval, i.e. the distance between adjacent points of time, is one second. Other time periods can also be used. The variable tₛₜₐₜₑ indicates how long the compressor has remained in the idle state. It is set to the minimum of the values tₛₜₐₜₑ−+1 s and t_{coasting} when the compressor is in idle state, otherwise, it is set to Os. t_{coasting} defines a maximum value for the idle time, the compressor can remain in idle state longer than the time t_{coasting}, but the variable tₛₜₐₜₑ+ is not further increased. This helps to reduce the number of states.

At a standstill, energy consumption remains constant E+:=E−. In idle state, the energy consumption is increased by the idle power Pidle multiplied by the time interval of 1 s: E+ := E−+P_{idle}*1 s. In load operation, the energy consumption increases by the load power P_{load} multiplied by the time interval of 1 s E+:=E−+P_{load}*1 s.

The pressure p is calculated from the air volume NV stored in the compressed air storage R1 and the ambient pressure as follows p:=((NV−/V)−1)*p_{amb}. The air volume NV stored in the compressed air storage R1 is calculated as follows:

$${NV}^{+} := {NV}^{-} - ( DVFR - CVFR ( t ) ) * 1 s .$$

The delivery volume flow DVFR is equal to Om₃/s at standstill and idle state. In the idle state, the compressor requires the idle power P_{idle} at all points of time—the produced compressed air volume remains 0 cubic meters per second, as the inlet valve of the compressor is closed, it cannot supply compressed air to the connected compressed air network because the minimum pressure check valve is closed due to the pressure difference between the internal pressure and the system pressure. In load operation, the delivery volume flow depends on the system pressure p.

In this simplified model, the three states of the compressor (standstill, idle state, and load operation) are connected through specific switching conditions. This enables the transition from one operating state to another, provided the switching conditions are met.

If the load command is set to LC==true in the “standby” state, the system transitions to the idle state. When transitioning from the discrete state Standby to the discrete idle state, the state variable ts1a1e is initialized with the value 0, and the energy counter is increased by the value Eₛₜₐᵣₜ E⁺ :=E⁻+Eₛₜₐᵣₜ− The value Eₛₜₐᵣₜ indicates the amount of energy required to start the compressor.

A transition from the “idle” state to the “load” state only occurs if the load command LC==true is set and the predefined idle time t_{loading} has been reached, i.e. tₛₜₐₜₑ=t_{loading}. The idle time is then set to O, and the energy is increased by the idle energy

$${E}_{loading} {E}^{+} := {E}^{-} + {E}_{loading} .$$

A transition from the “load” state to the “idle” state occurs when the load command is revoked (LC==false). The variable tₛₜₐₜₑ is set to Os, and the energy is increased by the value E_{unloading}. The switching energy for pressure reduction is accounted for via the parameter E_{unloading}.

A transition from the “idle” state to the “standby” state occurs when LC==false and tₛₜₐₜₑ>=t_{coasting}.

The model shown in FIG. 6 can be extended to include additional relevant parameters, such as the oil temperature, to represent the heating and cooling processes of the compressor.

For this purpose, the variables W*, Toil, WRG and Heat have been added in FIG. 7. The calculation is as follows:

WRG (Heatrecovery) describes the ability to determine whether heat recovery can be utilized or not. In standby state, the compressor cannot perform heat recovery. This is because the oil circuit is no longer active in standby state, so no oil can be transported through the heat exchangers of the heat recovery system. Consequently, the usable heat quantity HEAP that can be dissipated via the WRG system is equal to zero.

In standby state, no air compression occurs, and no heat is transferred to the oil during compression. Consequently, the temperature of the oil in the compressor's oil circuit Toil decreases, this cooling process occurs relatively slowly and can be represented by a cooling function (deltaToilAbkuehl) as a function of the dwell time in standby state tₛₜₐₜₑ, the ambient temperature Tamb, and the oil temperature at the previous point of time Tₒᵢₗ−. Accordingly, the stored heat quantity in the compressor W as a function of the parameters tₛₜₐₜₑ, T_{amb} and Tₒᵢₗ− can be described by a cooling function (W_{cooling}). The dwell time in the standby state ts1a1e is modeled analogously to the two states Idle and Load and is initialized with 0 at each transition into the standby state.

In the idle state (Idle), the increase in oil temperature Toil and the stored heat quantity W can be represented using functions (deltaToilIdle, W_{autheiz,idle}), which model the increase during idle operation. Heat recovery can only be utilized in idle state if a stored heat quantity greater than a specific threshold value W_{threshold} is present, depending on the system specifications. An alternative modeling approach can also be achieved through a predefined threshold for Tot. If the threshold is exceeded, heat can be recovered WRG:=true and the amount of dissipated heat Heat+ can be determined using a additional function HEAT based on the oil temperature and the heat quantity w+ at the current point of time. If the threshold value is undershot, no heat recovery can be used, and the transferable amount of heat Heat+ is equal to zero.

In the load state (Load), the quantities Toil+, W+, WRG, Heat+ can be determined analogously to the operating state Idle. However, a different heating function (deltaToilLoad) and a different function for determining the amount of heat w_{heat,load}) are used.

The following explains further aspects of the process:

In the process, the tree is pruned. When expanding the tree or graph, invalid load command combinations may be simulated, or invalid system states may be generated. For example, a load command combination could result in the lower or upper pressure limit being exceeded. As a result, this node/system state is not used as a starting point for further load command combinations at the next point in time. This is followed by cutting off this branch of the tree. As a result, the number of possible solutions and the solution space are significantly reduced, since cutting off this branch also eliminates the need to further examine all solutions derived from it. The valid system states are saved. The invalid system states do not need to be saved and can be deleted to save storage space.

To avoid the exponential growth of the solution space, nodes are merged if they represent a comparable system state. This approach is shown in FIG. 8 for four nodes 5, 6, 7, 8. From these four nodes 5, 6, 7, 8, two nodes 10, 9 are formed by merging. The nodes 5 and 6 describe load system states, and nodes 7 and 8 describe non-load system states. The Nodes 5 and 6 are merged in such a way that only the one with the lowest cost value is pursued as the new node 10. The nodes 7 and 8 are merged in such a way that only the one with the lowest cost value is pursued as the new node 9. To achieve this goal, it is advisable to divide the system pressure into a predetermined number of discretisation levels. For example, discretisation levels can be implemented in increments of 0.02 bar. The additional variables tstate, DVFR, and NV can also be divided into levels. These discretisation levels form the System pressure classes. Among the merged nodes 5, 6 and 7, 8, only the most energy-efficient one is pursued in the preferred design.

The difference between a brute-force approach from the prior art and the inventive process is now clearly visible in Figures Sa, Sb, and Sc. In the brute-force approach shown in Fig. Sa, an exponential growth of the number of nodes 11 occurs.

In the inventive process, as shown in Figures Sb and Sc, exponential growth in the number of nodes occurs only at the beginning. Since the maximum number of nodes is limited by the system state classes, there is no further growth in the number of nodes 12 beyond a certain point in time. Thus, the exponential growth of the solution space can be transformed into linear growth.

Figure Sc shown another possibility, where a cyclic reduction of the system classes is carried out, from which the next control commands originate at a later point of time. This helps to further reduce the number of nodes 13. The node reductions result from the following points.

“If a simulated load command violates an upper or lower pressure limit, this leads to pruning of the tree, and this node is not pursued further.

The greatest influence is exerted by the discretisation of the state variables. Through the discretisation of the system pressure, multiple nodes can be merged into a single node, and further combinations only need to be examined for this node. Furthermore, as previously mentioned, a cyclic reduction of the nodes can be carried out, in which the number of classes is additionally reduced based on the quality criterion at an exemplary interval of 20 seconds. The quality criterion is expressed by the cost function. At this point of time, for example, only 20% of the remaining classes can continue to be pursued. The other classes with their nodes are also no longer pursued, analogous to the nodes in the case of pruning. In this case, it is advisable to pursue the 20% of system pressure classes or system state classes that have the most favorable cost value at that point in time. The other classes with their nodes are also no longer pursued, analogous to the nodes in the case of pruning.

In another further embodiment, in addition to the purely energetic consideration, other influencing factors can also be taken into account in the cost value. Thus, the recoverable heat output of the compressor can also be determined.

“For this purpose, modeling using analytical equations is suitable, or if these would cause a significant increase in the computation time of the model, a metamodel-based optimization can be used. In this process, relationships between variables are learned using suitable metamodels before the actual optimization These metamodels can use response surfaces with linear, quadratic, or cubic basis functions, artificial neural networks, support vector regression, Gaussian processes, etc.

Upon reaching the final stage of the tree, it is known which node leads to the optimal solution of the given optimization problem. At the same time, the first load command of each node at the final stage was processed through the process, i.e., stored. Thus, the real compressor can be controlled using the first load command of the optimal solution of the tree. Subsequently, the entire process is run again for the current point in time, and the optimal solution is sought once more. This approach is necessary because the compressed air consumption can change within this time period, resulting in different compressed air demands for the examined time horizon. As a result, the boundary conditions of the optimisation problem fundamentally change. A typical time horizon is, for example, 10 minutes. For example, the time horizon of 10 minutes can be considered with a temporal resolution ranging from 0.1 seconds to 5 seconds, particularly 1 second.

### REFERENCE LIST

1 Single-Compressor Station
2 Compressed air consumer
3 Control algorithm
4 Pressure curve
5 Node/system state
6 Node/system state
7 Node/system state
8 Node/system state
9 Node/system state
10 Node/system state
11 Number of nodes
12 Number of nodes
13 Number of nodes

1. A computer-implemented process for control and/or regulation of a single-compressor station with a compressor, where an actual pressure and an actual operating state of the compressor are recorded, ensuring that despite possible fluctuating extraction of compressed fluid from a system including the single-compression station, the actual pressure is maintained within a pressure interval between an upper and a lower pressure limit, whereby with multiple points of time t0 to tn are defined, and a load command is determined and transmitted to the compressor, characterised in that:
a tree structure with a plurality of nodes in a form of simulated system states and edges in a form of simulated load commands is created according to the following procedural steps a) and b), whereby
a. to determine the load command to be transmitted to the compressor, starting from the actual operating state at a current point of time t0, for a next point of time t1, different load commands and the resulting system states are simulated, whereby expected actual pressures and cost values are calculated for the system states, whereby a respective cost value depends on a required energy, whereby the system states are classified as invalid system states and valid system states, whereby at least the valid system states are stored, whereby for each valid system state the expected actual pressure at the point of time t1 is assigned and stored in a system state pressure class, whereby for each valid system state a control state of the compressor to be expected at the point of time t1 is determined and a control state class is assigned to this expected control state and stored, whereby all control states resulting from the simulated load commands are stored in the memory system states are selected, or a subset of the system states resulting from the simulated load commands is chosen, with the simulated load command being stored for each system state simulated at the point of time t1,
b. whereby for subsequent time points ti+1 (i=1 . . . n−1), starting from the selected system states at a point of time ti, different load commands and the resulting system states are simulated, with the expected actual pressures and cost values calculated for the system states, whereby the system states are classified as invalid and valid system states, with at least the valid system states being stored, and where each valid system state is assigned and stored in a system state pressure class based on the expected actual pressure at the point of time ti+1, whereby for each valid system state, a control state of the compressor expected at the point of time ti+1 is determined, and a control state class is assigned to this expected control state and stored, whereby for each system state simulated for the point of time ti+1 at least the originally simulated load command at the point of time t1 is stored, whereby for each system state resulting from the simulated load commands with the same system state pressure class and the same control state class, at least the system state with the lowest cost value is selected as a node at the point of time ti+1,
c. whereby from all system states selected at the point of time tn, a system state with a lowest cost value is determined,
whereby the load command stored for this single selected and determined system state at the point of time t1 is transmitted to the compressor.

2. The method according to claim 1, characterized in that system states whose expected actual pressure is above the upper pressure limit or below the lower pressure limit are discarded as invalid.

3. The method according to claim 1, characterized in that in step a. the subset of the system states resulting from the simulated load commands is selected, whereby for each system state resulting from the simulated load commands with the same system state pressure class and the same control state class, the system state with the lowest cost value is chosen as a node.

4. The method according to claim 1, characterized in that recovered heat is taken into account in a model for simulating system states, whereby the cost value is calculated from a function, whereby the additionally considers the recovered heat.

5. The method according to claim 1, characterized in that in process step b, for at least one point of time tk with k>=2 and k<n, the system state classes are sorted according to cost values, and only the system state classes with the lowest cost values are used to generate further system state classes for the next point of time.

6. The method according to claim 1, characterized in that adjacent points of time tj and tj+1 for j=0 to n−1 have an equidistant spacing.

7. The method according to claim 1, characterized in that adjacent points of time tj and tj+1 for j=0 to n−1 have an equidistant spacing of less than 10 seconds and more than 0.001 seconds.

8. The method according to claim 1, characterized in that n>=10, in particular n>=20, and n<=10,000.

9. The method according to claim 1, characterized in that the control state class is assigned depending on a timer state, wherein the timer state indicates how long the compressor has already remained in a currently simulated compressor state at a minimum.

10. The method according to claim 9, characterized in that the timer state is limited to a maximum value, even if the compressor has already remained in the currently simulated compressor state longer than the maximum value.

11. The method according to claim 1, characterized in that for each system state simulated at the point of time ti+1, at least the initially simulated load commands at the points of time t1 . . . tl are stored, where 1>=2 and k=10, and from all nodes selected at time tn, the system state with the lowest cost value is chosen, with the load commands t1 to tl stored for this single selected system state being transmitted as load commands to the compressor.

12. The method according to claim 1, characterized in that two lists are used: a first list in which the previous system states at the point of time tj are stored, and a second list in which the newly simulated system states at the point of time tj+1, derived from the previous system states based on possible load commands, are stored, wherein once all system states for the current point of time tj+1 have been calculated, invalid system states are removed from an associated solution space, and a reduction to the system state with the lowest cost value in each existing system state class is performed, and wherein the second list is then declared as the first list for the next point of time ti+1, while the original first list is deleted and a new second list is created.

13. The method according to claim 1, characterized in that only the system state with the lowest cost value or multiple system states, particularly the system states with the lowest cost values, are selected.

14. The method according to claim 1, characterized in that in process step b, not all selected system states are considered, and not all selected system states at the point of time ti generate additional nodes at the next point of time ti+1 whereby the selected system states are sorted by cost value, and only the system states with the lowest cost values generate further system states for the next point of time ti+1.
